(19) United States
(12) Patent Application Publication
(10) Pub. No.: US 2018/0067511 A1
(43) Pub. Date: Mar. 8, 2018

(54) Remote Power Management Module

(71) Applicants: Mark R. Gregorek, Mahwah, NJ (US); Arthur Charych, Setauket, NY (US)

(72) Inventors: Mark R. Gregorek, Mahwah, NJ (US); Arthur Charych, Setauket, NY (US)

(21) Appl. No.: 15/695,926

(22) Filed: Sep. 5, 2017

Related U.S. Application Data
(60) Provisional application No. 62/384,122, filed on Sep. 6, 2016.
(60) Provisional application No. 62/510,235, filed on May 23, 2017.

(51) Int. Cl. G05F 1/66; G05F 1/46

(52) U.S. Cl. CPC G05F 1/66; G05F 1/46

(57) ABSTRACT

A power control device is provided for adjusting the input power to a device. The power control device includes an input, an output, and two or more output levels. A device such as an electrical device, application, or tool is attached to the output of the power control device. Further, a switch couples the input of the power control device to a power source. Thereby, the output level of the power control device can be adjusted by turning on and turning off the power source within a period of time.

### CROSS-REFERENCE TO RELATED APPLICATION

This application claims priority to U.S. Provisional Application Ser. No. 62/384,122, filed on Sep. 6, 2016, and entitled “Remote Power Management Module (RPMM),” and claims priority to U.S. Provisional Application No. 62/510,235, filed on May 23, 2017, and entitled “Remote Power Management Module (RPMM),” which are hereby incorporated by reference herein in their entirety, including any figures, tables, equations or drawings.

### TECHNICAL FIELD

The system and methods disclosed herein relate to power management, and more particularly, to controlling the power input into a device.

### BACKGROUND

A common method of adjusting the power input into a device is the use of variable resistors, such as a rheostat and potentiometer, while a step-down transformer allows for a device with a low power input rating to be compatible with a high power supply greater than what the device is designed for. Typically, a variable resistor includes a resistive track and a wiper terminal. One end of the resistive track of the variable resistor and its wiper terminal are connected to a circuit. As a result, the variable resistor can limit the current in the circuit according to the position of the wiper. Variable resistors are generally used in tuning circuits and power control applications. Such devices are considered “linear” devices, because the power output from the variable resistor can be varied incrementally. A variable resistors may also be employed when an appliance is connected to or within a circuit having an attached power supply that is either fully on or off.

A step down transformer transfers electrical energy between two or more circuits through electromagnetic induction. Typically, the primary windings of the step-down transformer is attached to a high alternating current (AC) source which is reduced in the secondary windings based on the ratio of turns between the primary windings and the secondary windings. A low AC power device is attached to the secondary windings of the step-down transformer.

An inherent disadvantage in known variable resistors and step down transformers is the need for various mechanical components that can fail. Further, difficulties exist in adjusting the variable resistors to a specific power output, due to the incremental adjustment and in some cases the need for the full “linear” range is not necessary.

Therefore, there is a need in the art for a power management system that can be set to pre-determined output levels.

### SUMMARY

The Remote Power Management Module (RPMM) disclosed herein is a controllable, multi□stage power supply modulator that has a plurality of output levels. In the preferred embodiment, the RPMM has more than two (2) and less than five (5) pre□set output levels from the input power of the RPMM. The pre□set levels are preferably established based on the desired use. As a result, the RPMM can adjust the power input into a device attached to the RPMM similar to the functions of a rheostat and potentiometer, without the use of a variable resistor terminal. In some embodiments, the RPMM can adjust the power input into a device attached to the RPMM similar to a step-down transformer, without the need of a core or windings. It is well□known in the art that household, hobby, and workforce related appliances, such as electrical devices and tools have variable speed/power settings. The variable control dial or rocker arm for low, medium, and high settings utilize rheostats and potentiometers located physically in the tool, electrical device, or appliance. The benefits of the broad inventive concepts disclosed herein are readily apparent as the RPMM exhibits a plurality of output levels, which can be configured to correspond to a low, medium, and high speed settings for a tool, electrical device, or appliance. In some embodiments, the RPMM is a separate component from the tool, electrical device, or appliance, thereby improving the ease of manufacturing said tool, electrical device, or appliance, because configuring the speed setting is controlled by the RPMM. In addition, the broad inventive concepts disclosed herein further allows for the acceptance of various tools, electrical devices, or appliances that do not contain power modulation components. In some embodiments, the RPMM is activated by the power supply that is utilized. In addition to having a plurality of preset output levels, the power supply modulator may include more advanced modulating systems such as a microprocessor, switch, resistor, or any similar components capable of regulating the output level.

### BRIEF DESCRIPTION OF THE DRAWINGS

The detailed description makes reference to the accompanying figures wherein:

FIG. 1 illustrates a bock diagram depicting a power control device in accordance with the various embodiments disclosed herein;

FIG. 2 illustrates a flowchart depicting a process;

FIG. 3 illustrates a flowchart depicting a process; and

FIG. 4 illustrates a flowchart depicting a process.

Other objects, features, and characteristics of the broad inventive concepts, as well as methods of operation and functions of the related elements of the structure and the combination of parts, will become more apparent upon consideration of the following detailed description with reference to the accompanying drawings.

### DETAILED DESCRIPTION OF THE PREFERRED EMBODIMENT

A detailed illustrative embodiment of the broad inventive concepts is disclosed herein. However, techniques, methods, processes, systems, and operating structures may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, electronic or otherwise, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. The following presents a detailed description with reference to the figures.

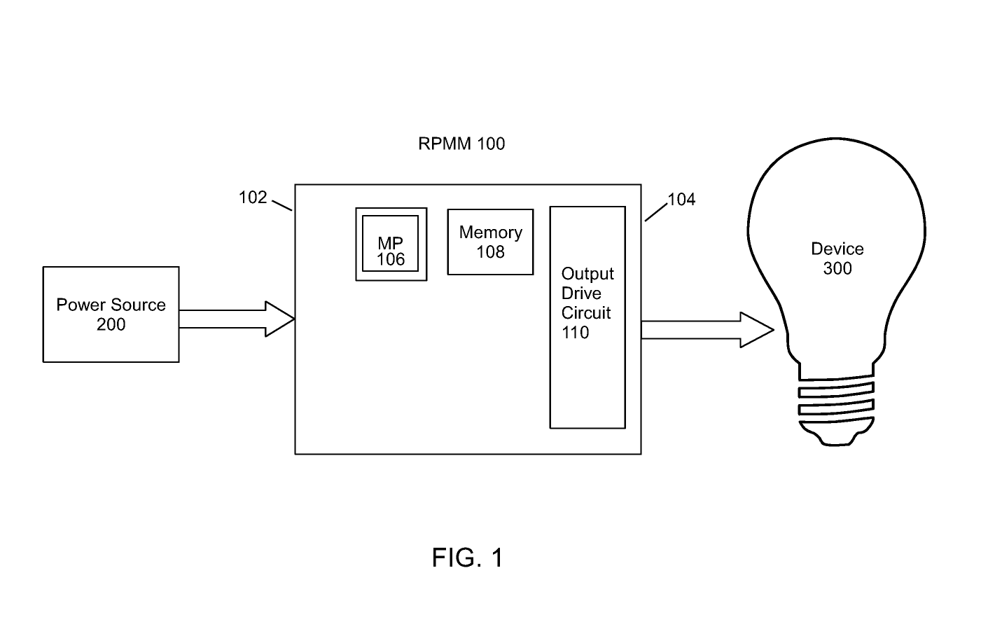

Referring initially to FIG. 1, shown is an exemplary block diagram of a remote power management module (RPMM). RPMM 100 comprises input 102 and output 104. In the preferred embodiment, power source 200 is coupled to input 102. Power source 200 can comprise a single phase or three phase alternating current (AC) source, or a direct current (DC) source. Further, power source 200 can include an internal switch or a switch can be coupled between power source 200 and input 102 to turn on and turn off the output power of power source 200 transmitted to RPMM 100. RPMM 100 further comprises microprocessor 106 and memory 108. The configuration of the output level of RPMM 100 is stored in memory 108. In some embodiments memory 108 is read-only memory (ROM) or erasable programmable read-only memory (EPROM). In the preferred embodiment, the configuration of the output levels stored in memory 108 comprises 30 Volts (V), 60 V, and 120 V. In one embodiment, the RPMM includes a Bluetooth controller. In this embodiment, the Bluetooth controller allows configuration of the plurality of output levels and/or the output level of the RPMM utilizing Bluetooth communication. It would be readily apparent to one of ordinary skill in the art to utilize various other communication methods, such as a wireless local area network (LAN) to configure and/or control the output of the RPMM, without departing from the broad inventive concepts disclosed herein

Microprocessor 106 controls output drive circuit 110 to set the output level of output 104. In one embodiment, the microprocessor can include hardware in order to continue operating when the power from the power source attached to the input of the RPMM is turned off. Exemplary hardware, includes but is not limited to an internal battery, which can be charged when the power from the power source attached to the input of the RPMM is turned on. In an embodiment where the power source is an AC source, the output drive circuit can comprise a semiconductor switch, for example a thyristor, positioned in series between the AC source and the device attached to the output of the RPMM. Thereby, the microprocessor configures the output level of the RPMM by controlling when the semiconductor switch is conductive or nonconductive for portions of the cycle of the AC source. It would be apparent to one of ordinary skill in the art to utilize other circuits to control the output level from an AC source, without departing from the spirit of the broad inventive concepts disclosed herein. In an embodiment where the power source is a DC source, the output drive circuit can comprise a switch mode circuit, for example a buck-boost regulator. Thereby, the microprocessor can control the output level by adjusting the duty cycle of the switch mode circuit.

As shown in FIG. 1, device 300 is coupled to output 104 of RPMM 100. Device 300 is shown as a light fixture, which can be configured to receive an incandescent, compact fluorescent (CFL), light emitting diode (LED), or Halogen bulb. Thereby, RPMM 100 can vary the intensity of a bulb attached to the light fixture by adjusting the output level of output 104. In some embodiments, the RPMM is integrated into the light fixture. It would be apparent to one of ordinary skill in the art to couple any appliance, tool or device to output 104 of RPMM 100, without departing from the spirit of the broad inventive concepts disclosed herein.

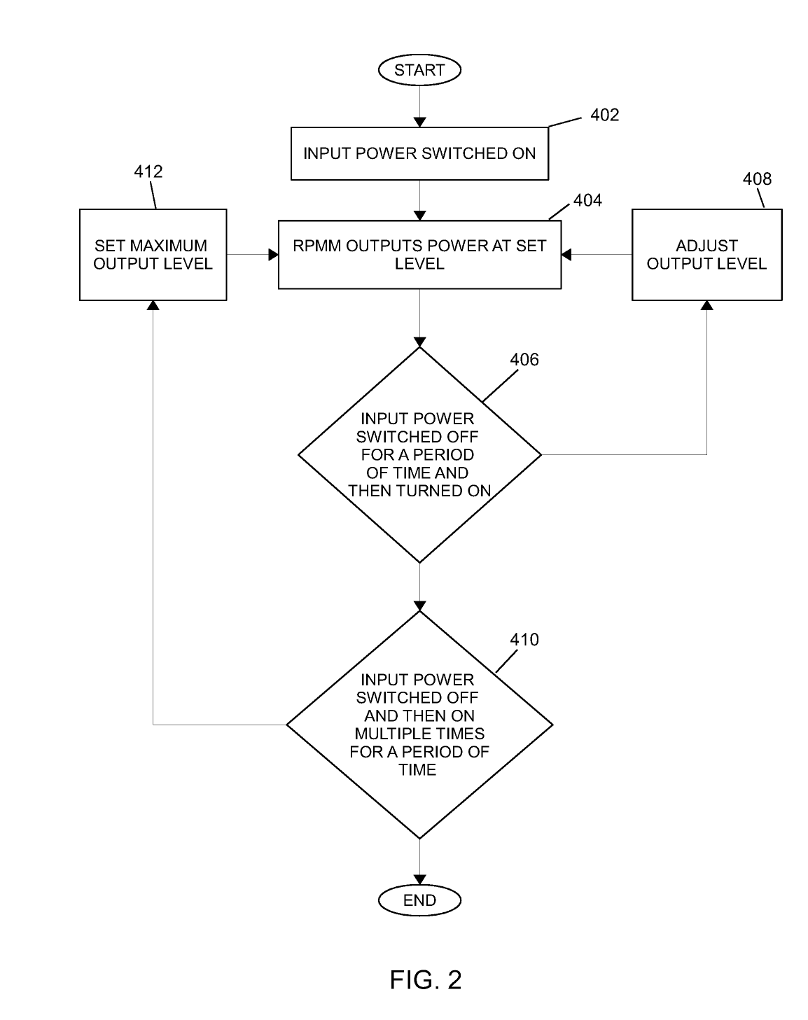

FIG. 2 depicts a flowchart representing the process of adjusting the output level of a RPMM in accordance with the broad inventive concepts disclosed herein. First in step 402, the power from a power source coupled to the input of the RPMM is turned on. In step 404, the RPMM outputs power at an output level. In the preferred embodiment the RPMM comprises three output levels: 30 V, 60 V, and 120 V. Further, the RPMM is initially configured to a default output level of 30 V.

Next, in step 406, the power source coupled to the input of the RPMM is turned off for a period of time and then turned on to configure the output level of the RPMM. In one embodiment, the period of time does not exceed five seconds. Thereafter, in step 408, the output level of the RPMM is adjusted. In the preferred embodiment, the output level is adjusted to the next higher sequential setting, for example 60 V, which would increase the intensity of a bulb attached to the output of the RPMM.

To set the output level to the maximum setting, in step 410, the power source coupled to the input of the RPMM is turned off and then turned on multiple times for a period of time. Thereafter, in step 412, the output level of the RPMM is set to the maximum output level. For example, the power source coupled to the input of the RPMM can be turned off and on three times within a five second period, to configure the output level of the RPMM to the maximum output level of 120 V. In some embodiments, the RPMM can be configured such that when the power source coupled to the input of the RPMM is turned off and then turned on, the output level will be configured to the lowest, highest, or any output level. It is also contemplated that when the power source coupled to the input of the RPMM is deactivated in this manner, the output levels will sequence through the same pre□set output values. It is further contemplated that if the power source is terminated at any time in this embodiment, the output of RPMM device will remain in the off position, thereby terminating any power to the appliance, tool, or device attached to the output of the RPMM.

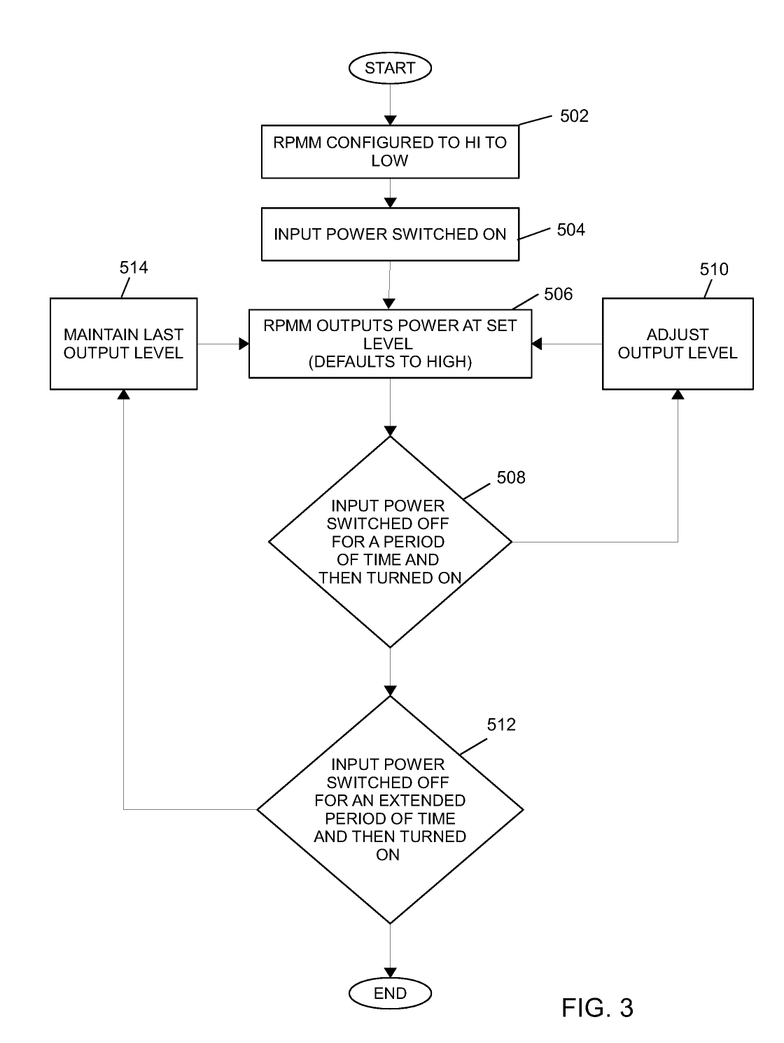

FIG. 3 depicts a flowchart representing the process of adjusting the output level of a RPMM in accordance with the broad inventive concepts disclosed herein. The RPMM device can vary the power intensity of a bulb linearly, e.g., from full intensity to dim, or from a dim setting that gradually increases to full intensity. First in step 502, the RPMM is configured to HI to LOW. In some embodiments, the RPMM device is set to HI to LOW with a small toggle switch. Next, in step 504, the power from a power source coupled to the input of the RPMM is turned on. In step 506, the RPMM outputs power at an output level. In this embodiment, the default output level is the highest output level.

Next, in step 508, the power source coupled to the input of the RPMM is turned off for a period of time and then turned on to configure the output level of the RPMM. Thereafter, in step 510, the output level of the RPMM is adjusted. In this embodiment, the output level is adjusted to the next lowest sequential output level, which would decrease the intensity of a bulb attached to the output of the RPMM. The process of adjusting the output level in step 510 will cycle the output level from the highest output level to the lowest output level until the power from a power source coupled to the input of the RPMM is turned off for an extended period of time.

To maintain the last output level after the power from a power source coupled to the input of the RPMM is turned off, in step 512, the power is turned on within an extended period of time. For example, the power from a power source coupled to the input of the RPMM is turned on within fifteen seconds. Thereafter, in step 514, the output level of the RPMM is configured to maintain the last output level. Otherwise, when the power from a power source coupled to the input of the RPMM is turned on after the extended period of time, the RPMM device cycles from the highest output level to the lowest output level.

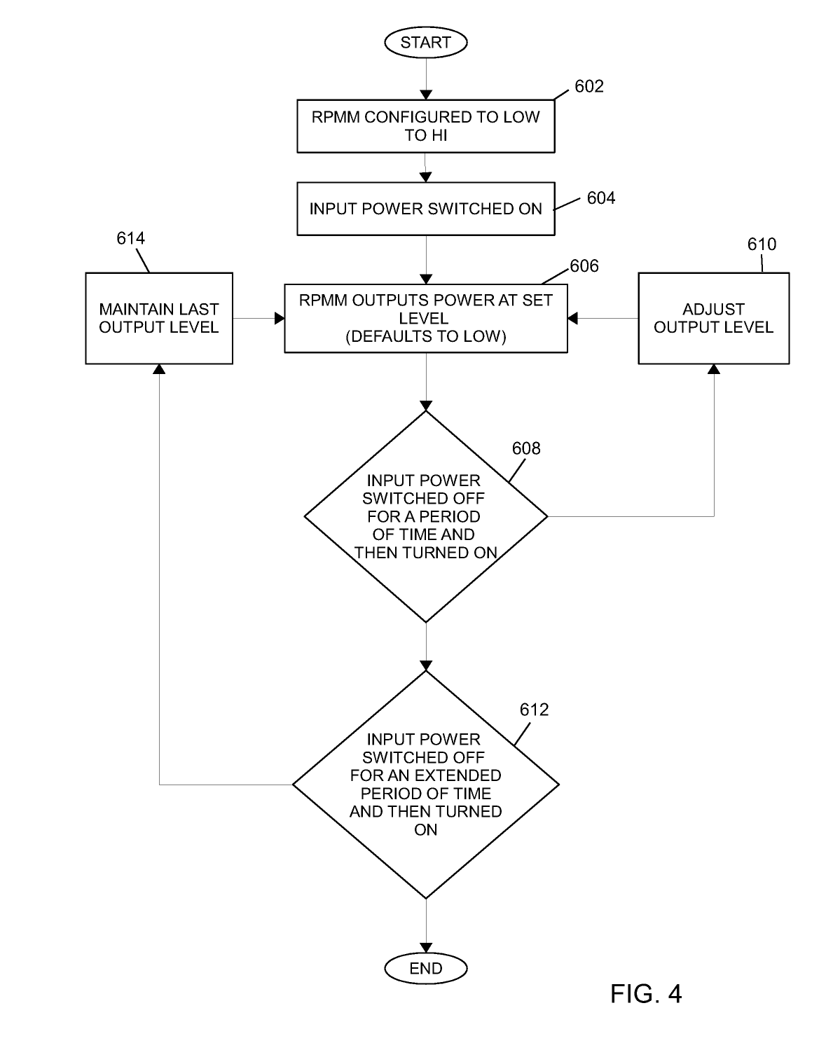

FIG. 4 depicts a flowchart representing the process of adjusting the output level of a RPMM in accordance with the broad inventive concepts disclosed herein. First in step 602, the RPMM is configured to LOW to HIGH. In some embodiments, the RPMM device is set to LOW to HIGH with a small toggle switch on the side of the RPMM device. Next, in step 604, the power from a power source coupled to the input of the RPMM is turned on. In step 606, the RPMM outputs power at an output level. In this embodiment, the default output level is the lowest output level.

Next, in step 608, the power source coupled to the input of the RPMM is turned off for a period of time and then turned on to configure the output level of the RPMM. Thereafter, in step 610, the output level of the RPMM is adjusted. In this embodiment, the output level is adjusted to the next highest sequential output level, which would increase the intensity of a bulb attached to the output of the RPMM. The process of adjusting the output level in step 610 will cycle the output level from the lowest output level to the highest output level until the power from a power source coupled to the input of the RPMM is turned off for an extended period of time.

To maintain the last output level after the power from a power source coupled to the input of the RPMM is turned off, in step 612, the power is turned on within an extended period of time. For example, the power from a power source coupled to the input of the RPMM is turned on within fifteen seconds. Thereafter, in step 614, the output level of the RPMM is configured to maintain the last output level. Otherwise, when the power from a power source coupled to the input of the RPMM is turned on after the extended period of time, the RPMM device cycles from the lowest output level to the highest output level.

In yet another embodiment according to the broad inventive concepts disclosed herein, the RPMM includes a memory function. After a desired output level is reached the setting can be stored by turning off and then turning on the power from a power source coupled to the input of the RPMM. Thereby once the power from a power source coupled to the input of the RPMM is turned off, and regardless how long the power is off, once the power is turned on, the output level will be configured to the last stored setting. In one example the stored output level can be cleared by switching the power off and then back on again from a power source coupled to the input of the RPMM.

While the disclosure has been described with reference to the preferred embodiment, which has been set forth in considerable detail for the purposes of making a complete disclosure, the preferred embodiment is merely exemplary and is not intended to be limiting or represent an exhaustive enumeration of all aspects of the broad inventive concepts disclosed herein. It will be apparent to those of skill in the art that numerous changes may be made in such details without departing from the spirit and the principles of the inventive concepts disclosed herein. It should be appreciated that the inventive concepts are capable of being embodied in other forms without departing from its essential characteristics.

What is claimed is:

1. A power control device, comprising:
an input;
an output; and
a plurality of output levels;
wherein a power source is coupled to the input;
wherein a device is coupled to the output; and
wherein the output cycles through the plurality of output levels.

2. The power control device of claim 1, wherein the plurality of output levels comprises at least two output levels.

3. The power control device of claim 2, wherein the plurality of output levels comprises 30 Volts, 60 Volts, and 120 V.

4. The power control device of claim 1, wherein the device is an electrical device, application, or tool.

5. The power control device of claim 4, wherein the plurality of output levels corresponds to a speed setting of the electrical device, application, or tool.

6. A power control device, comprising:
an input;
an output; and
a plurality of output levels;
a switch comprising an open position and a close position;
wherein the switch couples a power source to the input;
wherein a device is coupled to the output; and
wherein the output cycles through the plurality of output levels.

7. The power control device of claim 6, wherein the plurality of output levels comprises at least two output levels.

8. The power control device of claim 7, wherein the plurality of output levels comprises 30 Volts, 60 Volts, and 120 V.

9. The power control device of claim 6, further comprising a toggle switch comprising a HI-LOW position and a LOW-HI position.

10. The power control device of claim 9, wherein the HI-LO position of the toggle switch configures the output to cycles through the plurality of output levels from a highest output level to a lowest output level.

11. The power control device of claim 6, wherein the device is an electrical device, application, or tool.

12. The power control device of claim 6, wherein the plurality of output levels corresponds to a speed setting of the electrical device, application, or tool.

13. A method comprising the steps of:
configuring a power control device comprising an input, an output, and a plurality of output levels;
coupling a power source to an input of the power control device;
coupling a device to the output of the power control device;
turning on the power source; and
cycling through the plurality of output levels of the power control device.

14. The method of claim 13, wherein the step of cycling through the plurality of output level of the power control device comprises.
turning off the power source and then turning on the power source within a period of time.

15. The method of claim 13, wherein the step of cycling through the plurality of output level of the power control device comprises.
turning off the power source, turning on the power source, turning off the power source, and then turning on the power source within a period of time.

16. The method of claim 15, further comprising the step of cycling to a higher output level.

17. The method of claim 13, further comprising the step of turning off the output of the power control device.

18. The method of claim 17, wherein the step of turning off the output of the power control device comprises turning off and turning on the power source multiple times within a period to time.

19. The method of claim 18, wherein the step of turning off the output of the power control device comprises:
turning off the power source, turning on the power source, turning off the power source, turning on the power source, and then turning off the power source within a period of time.

20. The method of claim 13, wherein the step of configuring the power control device comprises:
setting the power control device to cycle from a high output level to a low output level.
